(19) United States
(12) Patent Application Publication
(10) Pub. No.: US 2005/0025447 A1
(43) Pub. Date: Feb. 3, 2005

(54) Multichannel optical attenuator for multiplexed signal

(76) Inventors: Frederic Verluise, Paris (FR); Veronique Dentan, Paris (FR); Jean-Luc Clavel, Chatenay Malabry (FR)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/483,255

(22) PCT Filed: Jul. 23, 2002
(86) PCT No.: PCT/FR02/02634

(30) Foreign Application Priority Data
Jul. 23, 2001 (FR) 01/09816

(51) Int. Cl. G02B 6/00

(52) U.S. Cl. 385/140; 385/11

(57) ABSTRACT

The invention relates to a multichannel optical attenuator for multiplexed signal. This optical attenuator includes at least one input optical fibre (1) intended to transport a set of light beams (2) centred on different wavelengths (λ₁, . . . , λₙ) and at least one output optical fibre (3) intended to transport said set of light beams. The beams (2) are sent to a polarisation splitting assembly (4). This splitting assembly (4) includes first polarisation splitting means (5) generating two light beams (8-9) linearly polarised along orthogonal directions and a first lens (6). Controllable means (10) liable to change the polarisation of said beams (8-9) are inserted between the first lens (6) and a second lens (11). A recombination assembly (13) comprising the second lens (11) and second polarisation splitting means (14) receives the light beams linearly (8-9) polarised from said controllable means (10) to send them to the output optical fibres (3).

This invention relates to a multichannel optical attenuator for wavelength multiplexed signal.

Developing telecommunications with increasingly large numbers of channels and modulation widths is opposed by the number of amplifiers necessary to the transport of the optical signal over long distances (approx. 10,000 km). During its optical path, the optical signal encounters in average one amplifier every 100 km. Still, the gain function of the amplifiers is great, but not flat, which involves exponential loss on least amplified channels. Quasi-flat gain amplifiers or corrected by fixed filters are currently implemented, but slight drifts still remain. Such drifts may be detrimental to the signal/noise ratio of a channel.

Besides, in the all-optical metropolitan fibre networks deployed currently, each channel may have an optical transparency in excess of 5,000 km and therefore undergo the same type of attenuation.

Gain Flattening Filters enable to address such problems. They are used on line on multiplexed signals. However, these gain flattening filters which are dedicated to the equalisation of the amplifiers' gain, exhibit a filtering function having rather rough resolution on quite a wide band (typically 5 nm). It is necessary moreover to fulfil this function in a programmable fashion because of the slight variations in the amplifiers' gain as a function of the temperature of time.

Besides, in metropolitan networks, each channel follows a different optical path associated with the interconnected loop structure of the networks thus the attenuation undergone by each channel is different. Consequently, the correction made for each channel should be notably differentiated.

Variable Optical Attenuators may be used at the head or the tail of a line on de-multiplexed channels to solve this type of problem. The variable optical attenuator is a component which attenuates the luminous intensity on a given channel. When there is more than one track, its functionality comes close to that of the gain flattening filter. However, even when the channels processed are very close, they may exhibit a contrast equal to the dynamics of the component.

The purpose of this invention is therefore to provide an optical system simple in its design and in its operating mode, compact and economic for the realisation of a high resolution variable attenuator. The operation of this system is simultaneously that of a gain flattening filter and of an optical attenuator. Its spectral response is continuous over a complete frequency band and its resolution is of the order of the channel with low insertion losses.

In this view, the invention relates to a multichannel optical attenuator for wavelength multiplexed signal including:
at least one input optical fibre intended to transport a set of light beams centred on different wavelengths (λ₁, . . . , λₙ),
at least one output optical fibre intended to transport said set of light beams,
   According to the invention,
a polarisation splitting assembly receiving the luminous flux from the input optical fibres, said splitting assembly including first polarisation splitting means generating two light beams linearly polarised along orthogonal directions and a first lens having an optical axis,
controllable means liable to change the polarisation of said beams being inserted at a common focus between the first lens and a second lens having an axis,
a recombination assembly comprising the second lens and second polarisation splitting means, said second lens sending the light beams linearly polarised from said controllable means to the second polarisation splitting means, and
it comprises programmable electronic control means of said means liable to change the polarisation.
   In different embodiment, this invention also relates to the following features which should be considered individually or in all their technically possible combinations:
the attenuator comprises a mirror situated after the controllable means sending back the light beams linearly polarised, the splitting assembly also forming a recombination assembly, the assembly including the first lens and the mirror forming a reflective system,
a dispersive system is inserted between the first polarisation splitting means and the first lens,
   said dispersive system is a diffraction grating dispersing at an angle the different wavelengths of the light beams linearly polarised and generating separate luminous fluxes centred on different wavelengths (λ₁, . . . , λₙ),
a first plate λ/2 is positioned between the first polarisation splitting means and the grating on the path of one of the two beams linearly polarised and a second plate λ/2 is positioned between the second lens and the second polarisation splitting means on the path of the other beam,
the plate λ/2 is located so that the light beams linearly polarised have a polarisation perpendicular to the lines of the grating,
a prism is placed between the diffraction grating and the first lens, said prism linearising the spatial distribution of the separate luminous fluxes as a function of the wavelength,
the polarisation splitting means include a polarisation splitter with parallel faces,
said polarisation splitter with parallel faces is made of calcite (CaCO₃),
the axis of the lens is positioned in the middle of the space separating the light beams linearly polarised from the first polarisation splitting means,
the lens is a lens whereof the digital aperture is such that no spatial overlapping of the separate fluxes incident on the lens occurs,
the lens conjugates the grooves of the grating on the mirror,
the object focus of the lens is aligned with the centres of the spots created by the beams linearly polarised from a single input fibre on the dispersive system,
a circulator is placed in front of said input fibre which is merged spatially with the output fibre,
the controllable means liable to change the polarisation of the beams include a barrel-mounted birefringent plate,
the controllable means liable to change the polarisation of the beams include a material with controllable birefringence,
the material with controllable birefringence comprises liquid crystals distributed into pixels,
each of the liquid crystals receives a single separate flux of wavelength λᵢ (i=1 to n),
the programmable electronic control means of said liquid crystals include a photo-conductive film deposited on the liquid crystals.

The invention will be described in detail with reference to the appended drawings whereon:

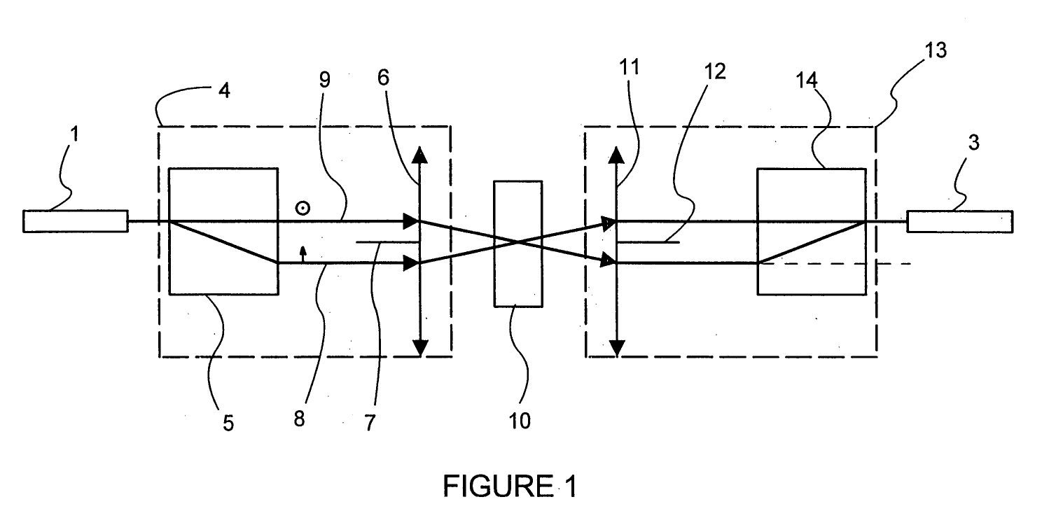

FIG. 1 is a schematic representation of a multichannel optical attenuator for multiplexed signal, according to the invention;

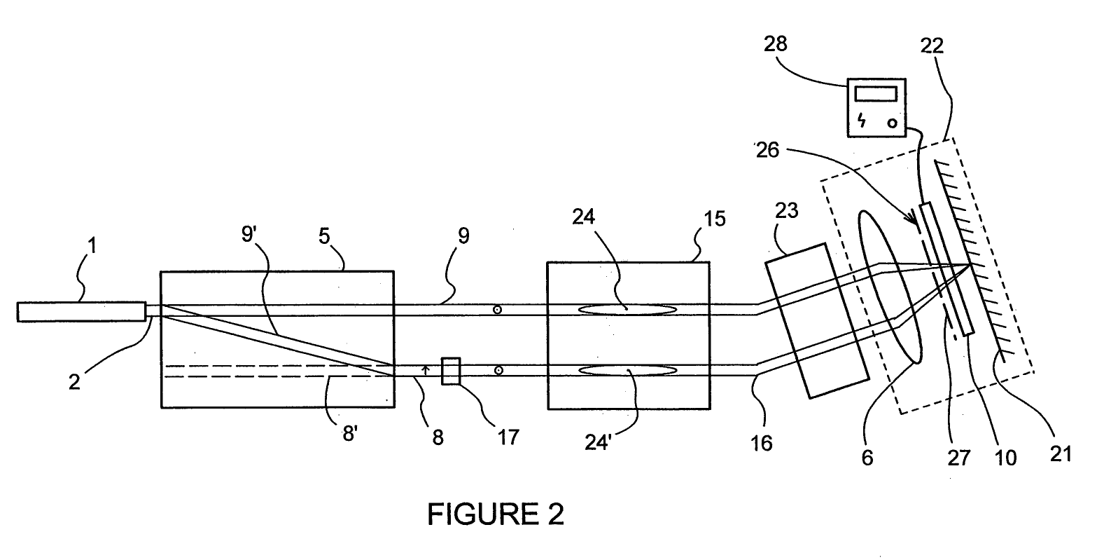

FIG. 2 is a schematic representation of an embodiment of a multichannel optical attenuator for a multiplexed signal with a reflective system seen laterally;

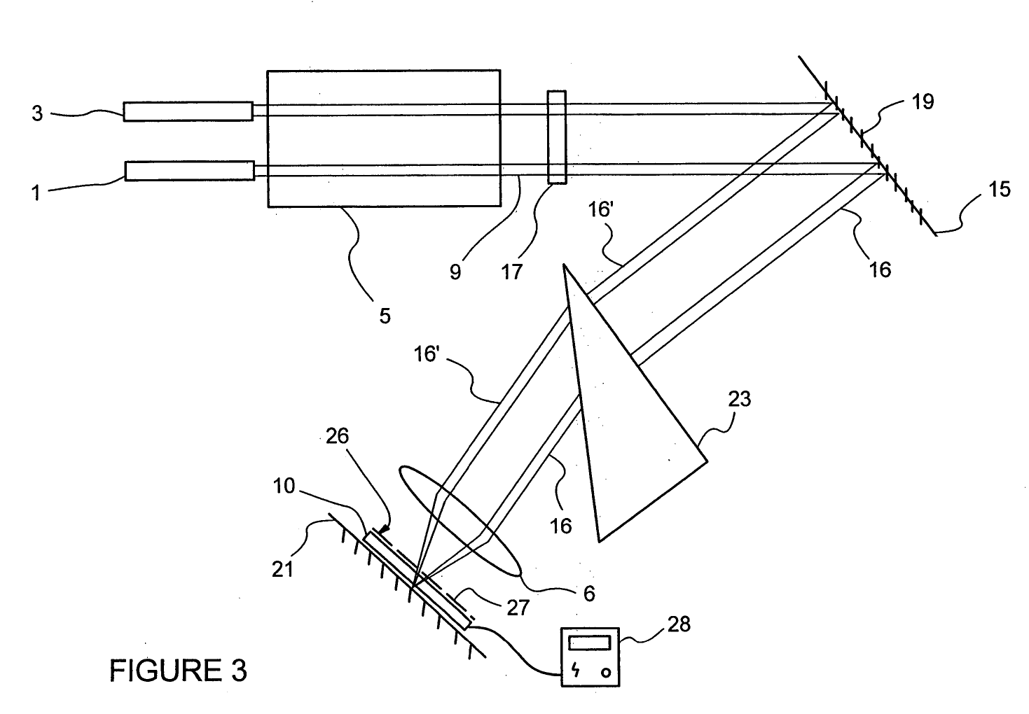

FIG. 3 is a schematic representation of the path of a beam centred on a wavelength λᵢ according to an embodiment, according to the invention, of a multichannel optical attenuator for multiplexed signal with a reflective system, seen from above;

The purpose of this invention is to use polarisation splitting means in order to generate from a beam centred on a wavelength λᵢ (i=1 to n) that should be attenuated, two light beams having orthogonal linear polarisation. The controllable imbalance is inserted in the polarisation of both beams linearly polarised so that this imbalance involves imperfect re-coupling of the energy after sending both beams to the same polarisation splitting or other polarisation splitting means. The energy lost being linked directly to the imbalance injected in the polarisation of both beams, the attenuation of the beam centred on the wavelength λᵢ may thus be controlled.

The multichannel optical attenuator for multiplexed signal includes at least one input optical fibre 1 intended to transport a set of light beams 2 centred on different wavelengths (λ₁, . . . , λₙ). The system also includes at least one output optical fibre 3 intended to transport said set of light beams. The set of light beams 2 from the input optical fibres 1 is sent to a polarisation splitting assembly 4. Such assembly 4 comprises first polarisation splitting means 5 and a first lens 6 having an optical axis 7. The first polarisation splitting means 5 generate from an incident beam 2 two parallel beams 8-9 and with orthogonal linear polarisation. Both two beams linearly polarised 8-9 thus realised are sent to the first lens 6. According to an embodiment, the optical axis 7 of the first lens 6 is placed in the middle of the space separating the light beams linearly polarised 8-9.

According to FIG. 1, this first lens 6 sends both light beams linearly polarised 8-9 to controllable means 10 liable to change the polarisation of said beams 8-9. These controllable means 10 are inserted at a common focus between the first lens 6 and a second lens 11 having an axis 12. The optical axis 12 of the second lens 11 is also placed in the middle of the space separating the light beams linearly polarised 8-9. After flowing through said controllable means 10, the beams 8-9 are sent to a recombination assembly 13. This recombination assembly 13 comprises the second lens 11 and second polarisation splitting means 14. According to an embodiment, the polarisation splitting means 5, 14 include a polarisation splitter with parallel faces.

Advantageously, this polarisation splitter is made of calcite (CaCO₃).

According to an embodiment, both parallel beams 8-9 and with orthogonal linear polarisation generated from an incident beam 2 by the first polarisation splitting means 5 are sent to a dispersive system 15. This dispersive system 15 is inserted between the first polarisation splitting means 5 and the lens 6. Advantageously, the dispersive system is a grating. It disperses at an angle the different wavelengths and generates separate luminous fluxes 16 centred on different wavelengths (λ₁, . . . , λₙ).

When the grating 15 depends to a certain extent on the polarisation and transmitted power stability is required, one should add, on one of the paths of the light beams linearly polarised 8-9 from the first polarisation splitting means 5, a plate λ/2 17. The axes of said plate 17 are then parallel to the axes 18 of the first polarisation splitting 5 means. At the output of the first splitting means 5, a first beam linearly polarised 8 has a polarisation direction parallel to the grooves 19 of the grating 15 while the second 9 has a polarisation perpendicular to these grooves 19. As the losses generated during the dispersion of a luminous beam linearly polarised 8-9 on the grating 15 are minimised when said beam 8-9 exhibits a polarisation perpendicular to the grooves 19 of the grating 15, said 17 plate is placed on the path of the first beam 8. This plate 17 rotates the polarisation parallel to the first beam 8 of 90°. The first beam 8 thus obtained as well as the second beam 9 excite the grating 15 with a linear polarisation perpendicular to the grooves 19 thereby reducing the losses during dispersion. A second plate λ/2 20 is placed in the recombination assembly 13 between the second lens 11 and the second polarisation splitting means 14 symmetrically to the first plate 17 in relation to the controllable means 10.

In another embodiment and according to the FIGS. 2 and 3, the optical attenuator comprises a mirror 21 situated after the controllable means 10. The separation assembly 4 also forms a recombination assembly 13. By reflective system 22 is meant the assembly including the mirror 21 and the first lens 6. Both parallel beams 8-9 and with orthogonal linear polarisation generated from an incident beam 2 by the first polarisation splitting means 5 are sent to a dispersive system 15. According to an embodiment, this dispersive system 15 is a grating. It disperses at an angle the different wavelengths and generates separate luminous fluxes 16 centred on different wavelengths (λ₁, . . . , λₙ).

When the grating 15 depends to a certain extent on the polarisation and when transmitted power stability is required, a plate λ/2 17 is added on one of the light beams linearly polarised 8-9. The axes of said plate 17 are then parallel to the axes of the first polarisation splitting means 5. This plate 17 is placed on the path of the first beam 8 whereof the polarisation is parallel and then rotates this polarisation by 90°. The first beam 8 thus obtained as well as the second beam 9 then excite the grating 15 with linear polarisation perpendicular to the grooves 19 thereby reducing the losses during of the dispersion.

At the output of the grating 15, the spacing d(λᵢ,λⱼ) with j=i+1 between the wavelengths dispersed at an angle is not perfectly linear. This non-linearity imposed by the dispersion law of the grating 15 may be advantageously compensated for by the implementation in combination with the grating 15, of a prism 23. This prism 23 is then positioned between the grating 15 and a reflective system 22. The prism 23 generates angular deviation of the luminous flux 16 according to the refraction laws. They are also non-linear, but this non-linearity being of reverse direction to that introduced by the dispersion laws of the grating 15, the total non-linearity is nil. There results that the adjunction of a prism 23 enables to obtain linear distribution of the luminous frequencies of the separate fluxes 16.

The separate fluxes 16 from the grating 15 are then sent to the reflective system 22. According to a preferred embodiment, the first lens 6 is a lens having an optical axis 7 and the association of this lens 6 with a mirror 21 forms a so-called ‘cat's eye’ assembly. The lens 6 conjugates the grooves 19 of the grating 15 on the mirror 21, the mirror 21 being at the image focus of the lens 6. An incident flux 16 is focused by the lens 6 on the mirror 21, is reflected by said mirror and then diverges in return on said lens 6 which generates a beam parallel 16′ to the incident beam 16. The digital aperture is advantageously taken so that no spatial overlapping of the separate fluxes 16 from different input optical fibres 1 occurs on the lens 6. When the object focus of the lens 6 is aligned with the respective centres 24′-24 of the spots created by the beams linearly polarised 8-9 from a single input fibre 1 on the dispersive system 15, a three-port circulator 25 is placed in front of said input fibre 1 which is merged spatially with the output fibre 3.

Means 10 liable to change the polarisation of the separate fluxes 16 are placed between the lens 6 and the mirror 21. These means 10 include according to an embodiment a barrel-mounted birefringent plate. In another embodiment, they include a material with controllable birefringence. According to a preferred embodiment, the material with controllable birefringence comprises liquid crystals 26 distributed into a matrix of pixels 27. The number of pixels 27 is at least equal to the number of separate fluxes 16 so that each of the liquid crystals 26 receives a single separate flux 16 of wavelength λᵢ(i=1 to n). It is then known that application by control means 28 of an adequate voltage on a liquid crystal 26 enables to change the polarisation orientation of the flux 16 which runs through the same. Advantageously, these electronic control means 28 are selected as programmable. The liquid crystals 26 receiving the separate fluxes 16 centred on wavelengths λ₁ that should be attenuated are therefore subjected to an adequate voltage. This voltage applied is then associated with a phase value introduced in the polarisation of the corresponding separate flux 16 and is proportional to the attenuation required. The liquid crystals 26 for which attenuation of the separate fluxes 16 running through the same is not required are left without any voltage. The programmable electronic control means 28 of the liquid crystals 26 are, in another embodiment, replaced with a photo-conductive film deposited on the matrix of liquid crystals 26. The surface of the photo-conductive film may then be considered as directly connected to the underlying matrix of liquid crystals 26. A fraction of the luminous power received by the photo-conductive film at a given point is then applied to the corresponding liquid crystal 26 generating an attenuation which is directly proportional to this luminous power. These control means 28 require however pre-adjustment in order to determine the attenuation law.

At the output of the reflective system 22, the luminous flux 16′ pass for the second time over the grating 17. They are then sent to the first polarisation splitting means 5. The luminous fluxes 16′ whereof the polarisation state is left unassigned after the passage of the liquid crystals 26 see their polarisations exchanged between the passages respectively on the way out and back on the grating 15. These beams 16′ are thus re-coupled at the output of the splitting means 5 and sent to at least one output optical fibre 3. For a flux 16 having flown through a liquid crystal 26 switched on, the passage by the polarisation splitting means 5 involves the formation of two beams 8′-9′ with orthogonal linear polarisation. The energy which is then passed on to the polarisation orthogonal to that of a separate flux 16′ left unassigned by the liquid crystals 26 is therefore not re-coupled at the output of the first polarisation splitting means 5. It can thus be seen that the phase value injected in the polarisation of a separate flux 16 at the liquid crystals 26 controls the energy which will not be re-coupled at the output of the first splitting means 5 and therefore to the attenuation required.

The elements of the optical system according to the invention will not be limited to the previous description and are liable to modifications as technologies evolve. Substitutions and/or modifications in the overall structure and in the details of the present system may be brought by a man of the art without departing from the framework of this invention.

This optical system may advantageously be used for the manufacture of high resolution variable attenuators. The operation of this component would then be that of a Gain Flattening Filter and of a Variable Optical Attenuator. Its spectral response would be continuous over a whole frequency band and its resolution would be of the order of the channel with low insertion losses.

1. A multichannel optical attenuator for wavelength multiplexed signal including:
at least one input optical fibre (1) intended to transport a set of luminous fluxes (2) centred on different wavelengths (λ₁, . . . , λₙ),
at least one output optical fibre (3) intended to transport said set of luminous fluxes, characterised in that it comprises
a polarisation splitting assembly (4) receiving the luminous flux (2) from the input optical fibres (1), said splitting assembly (4) including first polarisation splitting means (5) generating two light beams linearly polarised (8-9) along orthogonal directions and a first lens (6) having an optical axis (7),
controllable means (10) liable to change the polarisation of said beams (8-9) being inserted at a common focus between the first lens (6) and a second lens (11) having an axis (12),
a recombination assembly (13) comprising the second lens (11) and second polarisation splitting means, said second lens (11) sending the light beams linearly polarised (8-9) from said controllable means (10) to the second polarisation splitting means (14),
and in that it comprises programmable electronic control means (28) of said means liable to change the polarisation.

2. A multichannel optical attenuator according to claim 1, characterised in that it comprises a mirror (21) situated after the controllable means (10) sending back the light beams linearly polarised (8-9), the splitting assembly (5) also forming a recombination assembly (14), the assembly including the first lens (6) and the mirror (21) forming a reflective system (22).

3. A multichannel optical attenuator according to claim 1, characterised in that a dispersive system (15) is inserted between the first polarisation splitting means (5) and the first lens (6).

4. A multichannel optical attenuator according to claim 3, characterised in that said dispersive system (15) is a diffraction grating dispersing at an angle the different wavelengths of the light beams linearly polarised (8-9) and generating separate luminous fluxes (16) centred on different wavelengths (λ₁, . . . , λₙ).

5. A multichannel optical attenuator according to claim 4, characterised in that a first plate λ/2 (17) is positioned between the first polarisation splitting means (5) of polarisation and the grating (15) on the path of one of the two beams linearly polarised (8-9) and a second plate λ/2 (20) is positioned between the second lens and the second polarisation splitting means (14) on the path of the other beam.

6. A multichannel optical attenuator according to claim 5, characterised in that the plate λ/2 (17) is located so that the light beams linearly polarised (8-9) have a polarisation perpendicular to the lines (19) of the grating (15).

7. A multichannel optical attenuator according to one of the claims 4 to 6, characterised in that a prism (23) is placed between the diffraction grating (15) and the first lens (6), said prism linearising the spatial distribution of the separate luminous fluxes (16) as a function of the wavelength.

8. A multichannel optical attenuator according to claim 1, characterised in that each polarisation splitting means (5, 14) includes a polarisation splitter with parallel faces.

9. A multichannel optical attenuator according to claim 8, characterised in that said polarisation splitter with parallel faces is made of calcite (CaCO₃).

10. A multichannel optical attenuator according to claim 1, characterised in that the axis (7) of the first lens (6) is positioned in the middle of the space separating the light beams linearly polarised (8-9) from the first polarisation splitting means (5).

11. A multichannel optical attenuator according to any one of the claims 4, 5, 6, 8, 9, or 10, characterised in that the first lens (6) is a lens whereof the digital aperture is such that no spatial overlapping of the separate fluxes (16) incident on the lens (6) occurs.

12. A multichannel optical attenuator according to claim 11, characterised in that the first lens (6) conjugates the grooves (19) of the grating (15) on the mirror (21).

13. A multichannel optical attenuator according to claim 12, characterised in that the object focus of the lens (6) is aligned with the centres (24′-24) of the spots created by the beams linearly polarised (8-9) from a single input fibre (1) on the dispersive system (15).

14. A multichannel optical attenuator according to claim 13, characterised in that a circulator (25) is placed in front of said input fibre (1) which is merged spatially with the output fibre (3).

15. A multichannel optical attenuator according to claim 1, characterised in that the controllable means (10) liable to change the polarisation of the beams (8-9) include a barrel-mounted birefringent plate.

16. A multichannel optical attenuator according to claim 1, characterised in that the controllable means (10) liable to change the polarisation of the beams (8-9) include a material with controllable bi-refringence.

17. A multichannel optical attenuator according to the claim 16, characterised in that the material with controllable bi-refringence comprises liquid crystals (26) distributed into pixels (27).

18. A multichannel optical attenuator according to 17, characterised in that each of the liquid crystals (26) receives a single separate flux (16) of wavelength λᵢ(i=1 to n).

19. A multichannel optical attenuator according to any one of the claims 17 or 18, characterised in that the programmable electronic control means (28) of said liquid crystals (26) include a photo-conductive film deposited on the liquid crystals (26).
